(19) United States
(12) Patent Application Publication
(10) Pub. No.: US 2024/0080753 A1
(43) Pub. Date: Mar. 7, 2024

(54) UE-A Determination in Inter-UE Coordination

(71) Applicant: Fraunhofer-Gesellschaft zur Förderung der angewandten Forschung e.V., München (DE)

(72) Inventors: Dariush MOHAMMAD SOLEYMANI, Erlangen (DE); Martin LEYH, Erlangen (DE); Elke ROTH-MANDUTZ, Erlangen (DE); Shubhangi BHADAURIA, Erlangen (DE); Mehdi HAROUNABADI, Erlangen (DE); Dietmar LIPKA, Erlangen (DE)

(21) Appl. No.: 18/504,360

(22) Filed: Nov. 8, 2023

Related U.S. Application Data
(63) Continuation of application No. PCT/EP2022/062454, filed on May 9, 2022.

(30) Foreign Application Priority Data
May 10, 2021 (EP) 21173057.7

(51) Int. Cl. H04W 48/14; H04W 28/02; H04W 48/16; H04W 64/00

(52) U.S. Cl. CPC H04W 48/14; H04W 28/0226; H04W 48/16; H04W 64/003

(57) ABSTRACT

Communication system comprising first user equipment(s) and second user equipment(s),
wherein one or multiple user equipment(s) out of the first and second user equipment(s) are determined to be the first user equipment(s) based on pre-configured conditions or criteria or measurements or explicit request which are defined as follows:
wherein a geographical area and/or position and/or proximity of the first user equipment(s) are considered/used as a parameter to determine the one or more first user equipment(s); and/or
wherein a type of first or second user equipment(s) are considered/used as a parameter to determine the first user equipment(s); and/or
wherein a measured parameter is considered/used to determine the first user equipment(s); and/or
wherein another parameter, e.g., an entity of first or second user equipment, is considered/used to determine the first user equipment.

### CROSS-REFERENCE TO RELATED APPLICATIONS

This application is a continuation of copending International Application No. PCT/EP2022/062454, filed May 9, 2022, which is incorporated herein by reference in its entirety, and additionally claims priority from European Application No. EP 21173057.7, filed May 10, 2021, which is also incorporated herein by reference in its entirety.

Embodiment of the present invention referred to a Communication system, an user equipment and to a corresponding method. Further embodiments provide a UE-A Determination in Inter-UE Coordination.

### BACKGROUND OF THE INVENTION

FIG. 1 is a schematic representation of an example of a terrestrial wireless network 100 including, as is shown in FIG. 1(a), the core network 102 and one or more radio access networks RAN₁, RAN₂, . . . RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1(b) by the arrows pointing to “core”. The core network 102 may be connected to one or more external networks. The external network may be the Internet, or a private network, such as an Intranet or any other type of campus networks, e.g. a private WiFi or 4G or 5G mobile communication system. Further, some or all of the respective base station gNB₁ to gNB₅ may be connected, e.g. via the S1 or X2 interface or the XN interface in NR, with each other via respective backhaul links 116₁ to 116₅, which are schematically represented in FIG. 1(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, carrying for example a master information block, MIB, and one or more of a system information block, SIB, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. Note, the sidelink interface may a support 2-stage SCI. This refers to a first control region containing some parts of the SCI, and optionally, a second control region, which contains a second part of control information.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length. For example, in 5G a subframe has a duration of 1 ms, as in LTE. The subframe includes one or more slots, dependent on the subcarrier spacing. For example, at a subcarrier spacing of 15 kHz the subframe includes one slot, at a subcarrier spacing of 30 kHz the subframe includes two slots, at a subcarrier spacing of 60 kHz the subframe includes four slots, etc. Each slot may, in turn, include 12 or 14 OFDM symbols dependent on the cyclic prefix, CP, length.

The wireless communication system may be any single-tone or multicarrier system using frequency-division multiplexing, like the orthogonal frequency-division multiplexing, OFDM, system, the orthogonal frequency-division multiple access, OFDMA, system, or any other IFFT-based signal with or without CP, e.g. DFT-s-OFDM. Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard, or the IEEE 802.11 standard.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above described terrestrial wireless network also non-terrestrial wireless communication networks, NTN, exist including space borne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard, or the IEEE 802.11 standard.

In mobile communication networks, for example in a network like that described above with reference to FIG. 1, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. RSUs may have functionalities of BS or of UEs, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station, e.g., GSM, UMTS, LTE base stations, that may not support certain service, like NR V2X services.

When considering two UEs directly communicating with each other over the sidelink, e.g., using the PC5/PC3 interface, one of the UEs may also be connected with a BS, and may relay information from the BS to the other UE via the sidelink interface and vice-versa. The relaying may be performed in the same frequency band, in-band-relay, or another frequency band, out-of-band relay, may be used. In the first case, communication on the Uu and on the sidelink may be decoupled using different time slots as in time division duplex, TDD, systems.

FIG. 2(a) is a schematic representation of an in-coverage scenario in which two UEs directly communicating with each other are both connected to a base station. The base station gNB has a coverage area that is schematically represented by the circle 150 which, basically, corresponds to the cell schematically represented in FIG. 1. The UEs directly communicating with each other include a first vehicle 152 and a second vehicle 154 both in the coverage area 150 of the base station gNB. Both vehicles 152, 154 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a Mode 1 configuration in NR V2X or as a Mode 3 configuration in LTE V2X.

FIG. 2(b) is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 156, 158 and 160 are shown directly communicating with each other over a sidelink, e.g., using the PC5 interface. The scheduling and/or interference management of the V2V traffic is based on algorithms implemented between the vehicles. This configuration is also referred to as a Mode 2 configuration in NR V2X or as a Mode 4 configuration in LTE V2X. As mentioned above, the scenario in FIG. 2(b) which is the out-of-coverage scenario does not necessarily mean that the respective Mode 2 UEs in NR or mode 4 UEs in LTE are outside of the coverage 150 of a base station, rather, it means that the respective Mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 150 shown in FIG. 2(a), in addition to the NR Mode 1 or LTE Mode 3 UEs 152, 154 also NR Mode 2 or LTE mode 4 UEs 156, 158, 160 are present. In addition, FIG. 2(b), schematically illustrates an out of coverage UE using a relay to communicate with the network. For example, the UE 160 may communicate over the sidelink with UE₁ which, in turn, may be connected to the gNB via the Uu interface. Thus, UE₁ may relay information between the gNB and the UE 160

Although FIG. 2(a) and FIG. 2(b) illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

It is noted that the information in the above section is only for enhancing the understanding of the background of the invention and, therefore, it may contain information that does not form conventional technology that is already known to a person of ordinary skill in the art.

### Technical Problem

In the autonomous resource allocation in NR V2X communication, UE-A may report a conflict or advantageous or not advantageous resources to UE-B through inter-UE coordination assisted information by which, for example, the hidden terminal problem and collisions are avoided, resulting in a reliability improvement [1].

It is viable that regardless of the cast-type of communication (e.g. broadcast, group/multicast, unicast) between UE-B and the intended receivers, several UE-As may simultaneously transmit the same inter-UE assisted information message (AIM) to a UE-B. This causes redundancy of the AIMs, resulting in a communication increasing of overhead and probability of collision in the network.

This invention devises approaches by which transmission of the same AIMs by the multiple UE-As is avoided or reduced.

### State of the Art

Inter-UE coordination is seen as a solution that can help enhance the existing autonomous resource allocation, i.e., in Mode 2 of the NR V2X communication. In the WID for Rel-17 enhancement to NR sidelink [1] includes the following objective for mode 2 resource allocation enhancement:

Study the feasibility and benefit of solution(s) on the enhancement(s) in mode 2 for enhanced reliability and reduced latency in consideration of both PRR and PIR defined in TR37.885 (by RAN #91), and specify the identified solution(s) if deemed feasible and beneficial [RAN1, RAN2]
Inter-UE coordination with the following.
A set of resources is determined at UE-A. This set is sent to UE-B in mode 2, and UE-B takes this into account in the resource selection for its own transmission. Note: The solution should be able to operate in-coverage, partial coverage, and out-of-coverage and to address consecutive packet loss in all coverage scenarios.

The information transmitted from UE-A to UE-B is called the assisted information message (AIM), including a set of resources and other information. As for one type of AIM, UE-A sends UE-B the set of resources advantageous for UE-B's transmission. This way, this information can be used at least to solve the hidden-node and half-duplex problems.

Another type of AIM is that UE-A sends UE-B the set of resources not advantageous for UE-B's transmission. This information can address problems corresponding to the hidden terminal, half-duplex, consecutive packet loss, and exposed terminal.

Finally, UE-A may send UE-B the set of resources where a resource conflict is detected. This can be at least used to solve the half-duplex problem. More specifically, it can be used to assist TX UE-B, which experiences the half-duplex impact posterior to the initial transmission. In this way, the resource collision and half-duplex impact in retransmission and subsequent initial transmission can be avoided.

The AIM can be provided by UE-A to UE-B either in a pre-defined or a triggering manner. In the first case a UE-A sends the request to UE-B, and then UE-A reports the AIM to UE-B. In the latter case, UE-A actively informs the AIM to UE-B based on the pre-defined condition such as available resources, interference, half-duplex, and congestion status.

Recently, in RAN1 #104e-b, the inter-UE coordination was discussed, and the following agreements corresponding to the set of resources, condition, and UE-A and UE-B were agreed:

### Agreement:

Support the following schemes of inter-UE coordination in Mode 2:
   Inter-UE Coordination Scheme 1:
   The coordination information sent from UE-A to UE-B is the set of resources advantageous and/or non-advantageous for UE-B's transmission
   FFS details including a possibility of down-selection between the advantageous resource set and the non-advantageous resource set, whether or not to include any additional information other than indicating time/frequency of the resources within the set in the coordination information
   FFS condition(s) in which Scheme 1 is used
   Inter-UE Coordination Scheme 2:
   The coordination information sent from UE-A to UE-B is the presence of expected/potential and/or detected resource conflict on the resources indicated by UE-B's SCI
   FFS details including a possibility of down-selection between the expected/potential conflict and the detected resource conflict
   FFS condition(s) in which Scheme 2 is used
Study further to determine the conditions for UEs to be UE-A(s)/UE-B(s) for inter-UE coordination:
   Details include applicable scenario(s)/inter-UE coordination scheme(s)
   E.g., only UE(s) among the intended receiver(s) of UE-B can be a UE-A, any UE can be a UE-A, high-layer configured, etc.
   Including the possibility of being subject to certain conditions and/or capability

### Objective

The problem to be solved is currently open, but is expected to be further studied as described in the agreement above.

### SUMMARY

An embodiment may have a communication system including one or more first user equipment(s) and one or more second user equipment(s), wherein one or multiple user equipment(s) out of the one or more first and second user equipment(s) are selected to be the one or more first user equipment(s) at least based on explicit request which is defined as follows: wherein another parameter from an entity of first or second user equipment is considered/used to determine the one or more first user equipment(s); and/or wherein a second user equipment is considered to determine the one or more first user equipment; and/or wherein the one or more first user equipment(s) is determined to be the one or more first user equipment(s) sending an assisted information message when it is triggered based on an explicit request from the one or more second user equipment(s) or (pre-)configured conditions; wherein the assisted information message or coordination information is limited to be sent by the one or more first user equipment(s).

Another embodiment may have user equipment(s) configured to communicate within the inventive communication system and forming the one or more first or second user equipment.

Another embodiment may have a first user equipment of a communication system including one or more first user equipment(s) and one or more second user equipment(s), wherein one or multiple user equipment(s) out of the one or more first and second user equipment(s) are selected to be the one or more first user equipment(s) based on explicit request which is defined as follows: wherein another parameter, e.g. from an entity of first or second user equipment is considered/used to determine the one or more first user equipment(s); and/or wherein a second user equipment is considered to determine the one or more first user equipment; and/or wherein the one or more first user equipment(s) is determined to be the one or more first user equipment(s) sending an assisted information message when it is triggered based on an explicit request from the one or more second user equipment(s) or (pre-) configured conditions; wherein the assisted information message or coordination information is limited to be sent by the one or more first user equipment(s).

Another embodiment may have a second user equipment of a communication system including one or more first user equipment(s) and one or more second user equipment(s), wherein one or multiple user equipment(s) out of the one or more first and second user equipment(s) are selected to be the one or more first user equipment(s) based on explicit request which is defined as follows: wherein another parameter, e.g. from an entity of first or second user equipment is considered/used to determine the one or more first user equipment(s); and/or wherein the one or more first user equipment(s) is determined to be the one or more first user equipment(s) sending an assisted information message when it is triggered based on an explicit request from the one or more second user equipment(s) or (pre-)configured conditions; wherein the explicit request is sent by the one or more second user equipment(s); wherein the request is sent from the one or more second user equipment(s) requesting an information about the resources available to the one or more second user equipment(s).

Another embodiment may have a method for performing communication within a communication system including one or more first user equipment(s) and one or more second user equipment(s), the method including the step of determining, wherein one or multiple user equipment(s) out of the one or more first and second user equipment(s) are selected to be the one or more first user equipment(s) based on explicit request which is defined as follows: wherein another parameter, e.g. from an entity of first or second user equipment is considered/used to determine the one or more first user equipment(s); and/or wherein a second user equipment is considered to determine the one or more first user equipment; and/or wherein the one or more first user equipment(s) is determined to be the one or more first user equipment(s) sending an assisted information message when it is triggered based on an explicit request from the one or more second user equipment(s) or (pre-)configured conditions; wherein the assisted information message or coordination information is limited to be sent by the one or more first user equipment(s).

Another embodiment may have a non-transitory digital storage medium having a computer program stored thereon to perform the inventive method for performing communication within a communication system including one or more first user equipment(s) and one or more second user equipment(s), when said computer program is run by a computer.

Embodiments provide a communication system comprising one or more first user equipment(s) and one or more second user equipment(s), wherein one or multiple user equipment(s) out of the one or more first and second user equipment(s) are determined to be the one or more first user equipment(s) based on pre-configured conditions or criteria or measurements or explicit request or parameter which are defined as follows:
wherein a geographical area and/or position and/or proximity of the one or more first user equipment(s) are considered/used as a parameter to determine the one or more first one or more user equipment(s); and/or
wherein a type of first or second user equipment(s) are considered/used as a parameter to determine the one or more first user equipment(s); and/or
wherein a measured parameter is considered/used to determine the one or more first user equipment(s), or wherein the parameter is a measured parameter and considered/used to determine the one or more first user equipment(s); and/or
wherein another parameter, e.g., an entity of first or second user equipment, is considered/used to determine the one or more first user equipment.
wherein the parameter is another parameter or a higher layer parameter or a interUECoordinationScheme (e.g. enabling transmission of an advantageous resource set considering any candidate single-slot resource(s)), or a another parameter from an entity of the first or second user equipment, and considered/used to determine the one or more first user equipment(s).

According to embodiments, the differentiation between user equipments of a first type, also referred to as one or more first user equipments or UE-A, and user equipments of a second type, also referred to as one or more second user equipments or UE-B is made. The user equipments of a first type (UE-A) are configured to perform a coordination, i.e., may be configured to send assisted information message (AIM) or condition information. According to embodiments, the second type of user equipment(s) (UE-B) are configured to use this assisted information message or even to request the assisted information message from the first user equipment. According to embodiments, it may be assumed that potentially each user equipment may be used as UE of the first type (UE-A) or UE of the second type (UE-B). According to embodiments, rules are used to select one or more user equipments out of the multiple user equipments as user equipment of the first type. Embodiments of the present invention are based on the finding that preconfigured conditions or criteria or measurements or an explicit request is used. These conditions/criteria/measurements, in general parameters, are part of:
a geographical area and/or position and/or proximity of the one or more first user equipment(s) are considered/used as a parameter to determine the one or more first one or more user equipment(s); and/or
a type of first or second user equipment(s) are considered/used as a parameter to determine the one or more first user equipment(s); and/or
a measured parameter is considered/used to determine the one or more first user equipment(s); and/or
another parameter, e.g., an entity of first or second user equipment, is considered/used to determine the one or more first user equipment.

Due to the criteria/parameters for selecting the UE of a first type reliability improvements for NR (V2X communication) is used.

According to embodiments, the communication system uses sidelink communication, e.g., for V2X applications.

As outlined in state of the art, the inter-UE coordination is foreseen as a viable solution to leverage the resource allocation method in autonomous resource allocation to enhance the reliability and reduce the latency for NR V2X communication. Multiple UE-As may send inter-coordination information when triggering conditions are met, or explicit signaling messages are received. This invention targets different techniques to determine a specific UE-A from multiple UE-As to reduce the signaling overhead and enhance reliability. To this aim, the following embodiments are proposed:
Positioning/area-based UE-A Determination: wherein UE-A is determined considering the geographical area
Type-based UE-A Determination: wherein the type of UE-A is considered as a parameter to determine the UE-A.
Measurement-based UE-A Determination: wherein some measurement is taken into consideration in UE-A determination.
Entity to be identified as UE-A.

The major benefit of this invention is the reliability improvement NR V2X Communication. Reliability enhancement is considered a major objective in Rel-17 WI, and Inter-UE coordination has been considered as a solution to the reliability enhancement.

Another embodiment provides a first user equipment of a communication system comprising one or more first user equipment(s) and one or more second user equipment(s), wherein one or multiple user equipment(s) out of the one or more first and second user equipment(s) are determined to be the one or more first user equipment(s) based on pre-configured conditions or criteria or measurements or explicit request which are defined as discussed above.

Another embodiment provides a first user equipment (user equipment of a first type) selected out of one or multiple user equipments based on preconfigured conditions or criteria or measurements or explicit requests, which are defined as discussed above.

Another embodiment provides a (computer implemented) method for performing communication within a communication system comprising one or more first user equipment(s) and one or more second user equipment(s), the method comprising the step of determining, wherein one or multiple user equipment(s) out of the one or more first and second user equipment(s) are determined to be the one or more first user equipment(s) based on pre-configured conditions or criteria or measurements or explicit request which are defined as discussed above.

Below, different optional features for the above-discussed main aspects will be defined.

According to embodiments, the one or more first user equipment(s) is determined to be the one or more first user equipment(s) sending the assisted information message when it is triggered based on a (explicit) request from the one or more second user equipment(s) or (pre-) configured conditions. Alternatively or additionally, an assisted information message within the network is limited to be sent by the one or more first user equipment(s).

According to further embodiments, the one or more first user equipment(s) are configured to be determined as the one or more first user equipment(s) and/or one or more second user equipment(s) to transmit assisted information message or coordination information. Additionally or alternatively, the one or more first user equipment(s) and/or a further first user equipment may be configured to perform or transmit information regarding inter-user equipment(s) coordination.

According to another embodiment, the one or more first user equipment(s) are determined based on a certain position of the one or more first user equipment(s) and/or second user equipment(s) and/or a geographical area of the one or more first user equipment(s) and/or second user equipment(s) and/or proximity of the one or more first user equipment(s) to the second or another user equipment(s) and/or distance between the of the one or more first user equipment(s) and the second or another user equipment(s). For example, the one or more first user equipment(s) are determined based on fulfillment of at least one of the conditions below:
zone or zone length where the one or more first user equipment(s) are; and/or wherein the zone is indicated in control information;
a threshold is provided to determine the maximum allowed distance between the one or more first user equipment(s) and the one or more second user equipment(s);
a distance or a proximity derived from an absolute position of first and second user equipment(s) or a relative distance of first and second user equipment(s);
a distance or a proximity derived from geographical information of the one or more first and second user equipment(s) (e.g. from the GNSS or from measurements (e.g. relative distance), from the received signal strength (e.g. RSSI, RSRP), or from a signal runtime or from a SL positioning reference signal.

According to further embodiments, the one or more first user equipment(s) are determined based on a type parameter; wherein the type parameter is determined based on fulfillment of at least one of the conditions below:
the one or more first user equipment(s) are a relay UE;
the one or more first user equipment(s) are configured with a certain capability (e.g. at least sensing capability or feedback transmission);
the one or more first user equipment(s) are a non-power-saving user equipment(s) (e.g. no battery-based UE, but vehicular UE);
first user equipment(s) users a defined or predefined DRX configuration (e.g. same or similar UEs, UEs having the same on-duration).

According to embodiments, the type parameter is configured or (pre-) configured through the higher layer signaling.

According to further embodiments, the one or more first user equipment(s) are determined based on measurement or parameters; wherein the measurement or parameter is determined based on at least one of the conditions below:
Other nearby first user equipment(s) transmitting the same AIMs;
Number of first user equipment(s) transmitting the AIMs are beyond a (pre-) configured threshold;
Load of the network (based on e.g. CBR measurement);
Available/free resource of a user equipment(s) (e.g. may depend on how much resources are needed by the user equipment(s) itself);
relative velocity of the one or more first and second user equipment
received signal level;
QoS of itself towards intended second user equipment.

It should be noted that according to further embodiments, wherein the measurement or parameter that is used to determine the one or more first user equipment(s) is (pre-) configured by the higher signaling and transmitted on the (pre-) configured radio resources for the AIM or other resources identified through its sensing.

According to embodiments, the other parameters depending on the current state of the one or more first user equipment(s) and the cast type of the different entities. Note, the other parameter indicates an in coverage scenario (e.g., of the one or more first user equipment(s)). Here, the gNB may determine the one or more first user equipment(s). Alternatively, the other parameter may indicate an out of coverage scenario. According to another option, the other parameter may indicate different cast types out of a group comprising
Groupcast (e.g. the group head may determine UE-A);
Unicast (any of the following solution may apply, UE-A can be intended receiver of UE-B or Non-intended receiver of UE-B, which meets conditions to be determined as UE-A, the transmitting user equipment(s) could be UE-A to the receiving user equipment(s) and vice versa);
Broadcast (any of the following solution may apply: Any user equipment(s) could propose UE-A resources to be shared and UE-B decides which ones to use).

Another embodiment provides a user equipment configured to communicate within a communication system as defined above, like a sidelink communication system. Here, the user equipment forms a first or the second user equipment. According to embodiments, the user equipment may comprise one of the following: a power-limited UE, or a hand-held UE, like a user equipment(s) used by a pedestrian, and referred to as a Vulnerable Road User, VRU, or a Pedestrian UE, P-UE, or an on-body or hand-held user equipment(s) used by public safety personnel and first responders, and referred to as Public safety UE, PS-UE, or an IoT UE, e.g, a sensor, an actuator or a user equipment(s) provided in a campus network to carry out repetitive tasks and needing input from a gateway node at periodic intervals, a mobile terminal, or a stationary terminal, or a cellular IoT-UE, or a vehicular UE, or a vehicular group leader (GL) UE, or a sidelink (SL) relay, or an IoT or narrowband IoT, NB-IoT, device, or wearable device, like a smartwatch, or a fitness tracker, or smart glasses, or a ground based vehicle, or an aerial vehicle, or a drone, or a base station e.g. gNB, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink (SL) the wireless communication network, e.g. a sensor or actuator, or a transceiver, or any sidelink (SL) capable network entity.

According to further embodiments, the above-discussed approach may be implemented by a method for performing communication within a communication system comprising one or more first user equipment(s) and one or more second user equipment(s). The method comprises the step of determining one or multiple user equipment(s) out of the one or more first and second user equipment(s) are determined to be the one or more first user equipment(s) based on pre-configured conditions or criteria or measurements or explicit request which are defined as follows:
wherein a geographical area and/or position and/or proximity of the one or more first user equipment(s) are considered/used as a parameter to determine the one or more first one or more user equipment(s); and/or
wherein a type of first or second user equipment(s) are considered/used as a parameter to determine the one or more first user equipment(s); and/or
wherein a measured parameter is considered/used to determine the one or more first user equipment(s); and/or
wherein another parameter, e.g., an entity of first or second user equipment, is considered/used to determine the one or more first user equipment.

According to further embodiments, this method may be computer implemented. Thus, another embodiment provides a storage medium having stored thereon a program coded for performing, by running on a computer, the above method.

According to another embodiment, a UE may be configured with the higher layer parameter inter-UE coordination scheme 1 enabling transmission of an advantageous resource set considers any candidate single slot resource, e.g. as defined in clause 8.1.4. The candidate single slot resource(s) may satisfy one or more or all of the following conditions as advantageous resources:
resource(s) excluding those overlapping with reserved resource(s) indicated by a received SCI format 1-A whose RSRP measurement is higher than an RSRP threshold;
if the UE is a destination UE of a TB for whose transmission their advantageous resource set is being determined, resource(s) excluding slot(s) in which the UE does not expect to perform SL reception of the TB due to half duplex operation unless this condition is disabled by the higher layer parameter condition 1A to scheme 1 disabled.

According to further embodiments, an explicit request is used. For example, when the inter-UE coordination information transmission is triggered by reception of an explicit request, the advantageous resource(s) are determined (e.g. in the same way as described in clause (8.1.4)) with at least the following parameters indicated in the received explicit request.

In other words, this means that a UE that is configured to transmit an IUC message is considered to be UE-A (i.e., the first user equipment), when the first UE receives an explicit request from the second UE, i.e., UE-B.

### BRIEF DESCRIPTION OF THE DRAWINGS

Embodiments of the present invention will be detailed subsequently referring to the appended drawings, in which:

FIGS. 1a and 1b illustrate a schematic description of a communication system, where FIG. 1a shows a core network in combination with multiple radio access networks and FIG. 1b shows a radio access network including multiple base stations;

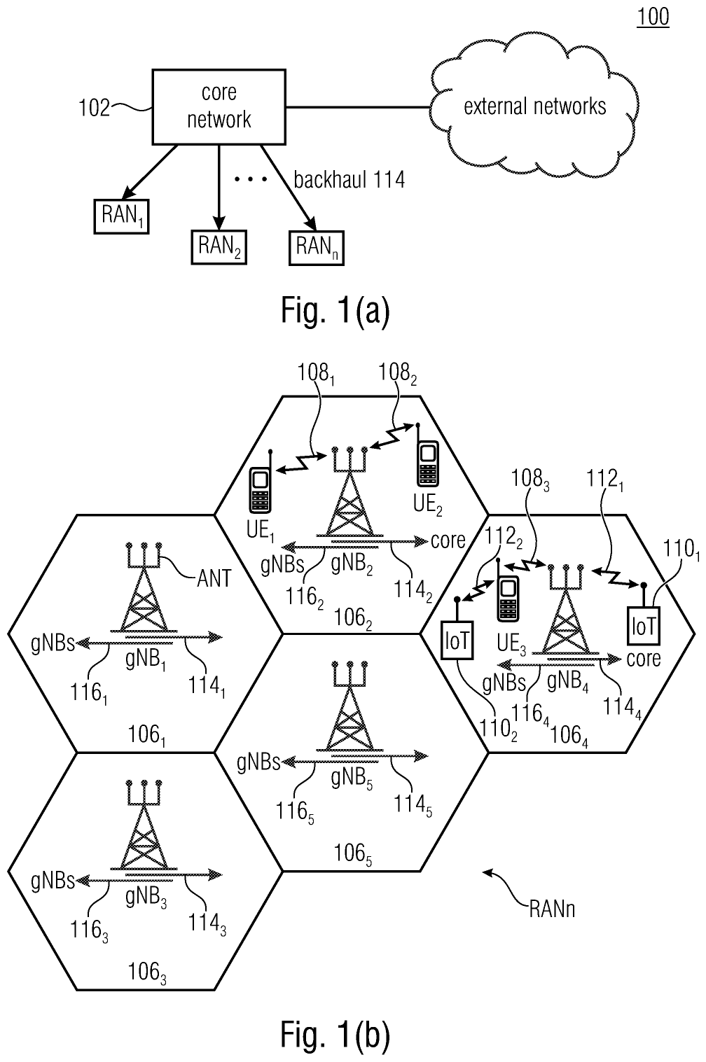

FIGS. 2a and 2b are schematic representations to illustrate the in-coverage and out-of-coverage scenario;

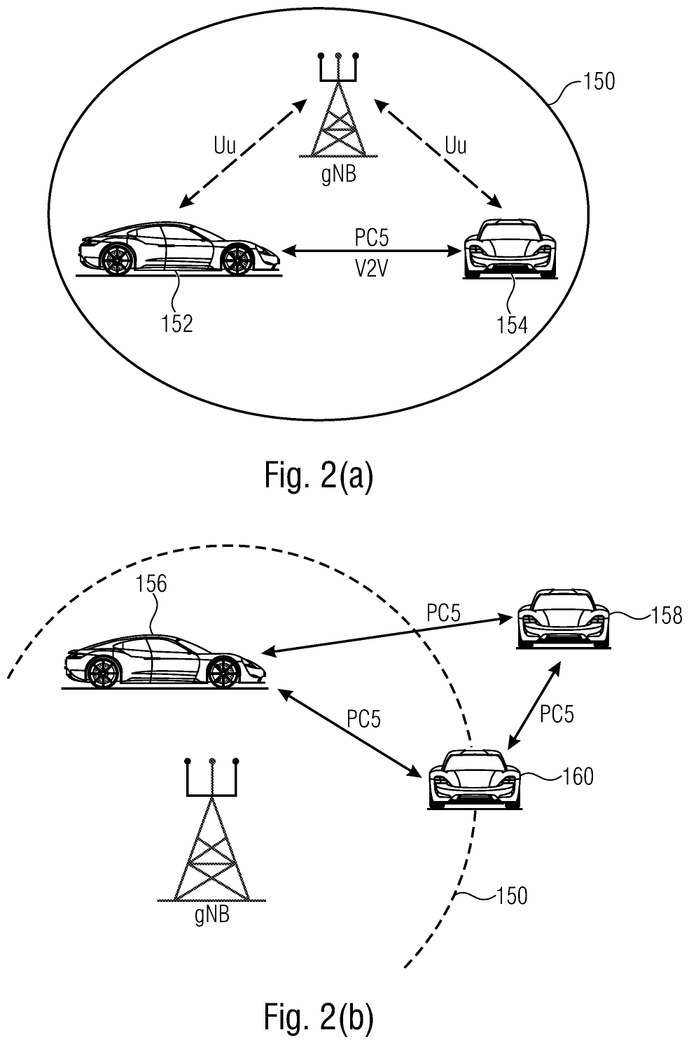

FIG. 3a is a schematic user equipment according to one embodiment; and

FIG. 3b is a schematic representation of a processor for performing the method according to embodiments.

### DETAILED DESCRIPTION OF THE INVENTION

Below, embodiments of the present invention will subsequently be discussed referring to the enclosed figures, wherein identical reference numerals are provided to objects having identical or similar function.

Before discussing hardware implementations of the present invention in detail, principles forming the basis of the present invention will be discussed first.

As mentioned above within the communication network, e.g., a communication network using sidelink communication, approaches using assisted information messages may be used. Often an assisted information message to be sent by a UE, here for example UE-A (user equipment of the first type) may be triggered by another UE, for example, UE-B (user equipment of the second type). In such a case, a trigger is sent by one UE/by UE-B a plurality of UEs may be in the situation to send the requested assisted information message, wherein collisions can occur when the number of so-called UE-As is too large. Below, principles for limiting the number of UEs determined a UE-A will be discussed.

Below, details regarding different criteria/different embodiment are given. Here, three main embodiment will be discussed:
Embodiment 1: Positioning/Geographical Area-based UE-A Determination
Embodiment 2: UE based Conditions to be fulfilled to determine UE-A, e.g. UE Type
Embodiment 3: Measurement-based Conditions to be fulfilled to determine UE-A

### Positioning/Area-Based UE-A Determination

According to an embodiment multiple UE-As may be triggered to send assisted information message (AIM), including a set of advantageous or not advantageous or post-collision or pre-collision resources, to the UE-B. One way to limit the number of UE-As transmitting AIM with the same or different contextual information is that UE-A is determined based on a certain position/geographical area/proximity/distance to UE-B fulfilling at least one of the conditions below:
any geographical area
e.g. zone (zone length), where e.g. UE-A is located in the same zone as UE-B
the geographical area could also be (pre-)configured by the higher layer signaling.
proximity based—e.g. distance between UE-A to UE-B,
e.g. a threshold is provided to determine the maximum allowed distance between UE-A and UE-B, e.g. communication range.
The distance/proximity can be derived from the absolute position of UE-A and UE-B or the relative distance between UE-A and UE-B
The position/distance could be derived from geographical information, e.g. from the GNSS or from measurements (e.g. relative distance) from the received signal strength (e.g. RSSI, RSRP) or the signal runtime or from the SL positioning reference signal
in a particular direction based on the angle of arrival

Expressed in other words, a UE may be determined as UE-A, in case same is in a specific geographical area (e.g., a (pre-) configured geographical area or the cell of UE-B) or in the proximity of UE-B or in a particular direction (e.g., as seen from UE-B).

### UE Type or Conditions as Pre-Requisite to Determine UE-A

According to embodiments, the number of UEs possibly to be determined as UE-A could be limited to specific types or conditions to be fulfilled.

For example, specific types of UEs are only allowed to be determined as the UE-A to send the AIM message to the UE-B. For example, a UE has to have at least one of the below conditions to be determined as UE-A:
a relay UE or
a UE with a certain capability for example at least sensing capability or feedback transmission
a non-power-saving UE (e.g. no battery-based UE, but vehicular UE) or
UE(s) using the same or similar DRX configuration e.g. UEs having the same on-duration.

Note the type of UE may according to embodiments be (pre-)configured through the higher layer signaling.

### Measurement-Based UE-A Determination

According to another embodiment UE-A can also be determined based on the measurement and configured parameters indicating restriction to determine UE-A or the number of UE-As.

For example regarding the max. number of UE-As, UE-A may monitor other UE-As transmitting the same or different AIMs to the UE-B, and then the AIM is triggered if the measurement that the UE-A undertakes is below a configured threshold.

The UE-A may at least undertake the following measurement considering the corresponding metrics:
Other nearby UE-As transmitting the same AIMs
Number of UE-As transmitting the AIMs are beyond a pre-configured threshold
Load of the network, based on e.g. CBR measurement
Available/free resource of a UE, e.g. may depend on how much resources are needed by the UE itself
The relative velocity of UE-A and UE-B
Received signal level, or QoS of itself towards intended UE-B.

The outlined parameters could be (pre-)configured by the higher signaling and transmitted on the (pre-)configured radio resources for the AIM or other resources identified through its sensing.

### Entity to be Identified as UE-A

Depending of the coverage state and the cast type different entities may determine UE-A according to further embodiments.

Out of coverage different cast types could be considered:
Groupcast:
e.g. the group head may determine UE-A
Unicast: Any of the following solution may apply:
UE-A can be intended receiver of UE-B or
Non-intended receiver of UE-B, which meets conditions to be determined as UE-A the transmitting UE could be UE-A to the receiving UE and vice versa
Broadcast: Any of the following solution may apply:
Any UE could propose UE-A resources to be shared and UE-B decides which ones to use

Here, the first UE (UE-A) may determine itself as UE-A or may alternatively be requested to determine itself as UE-A (request from UE-B).

### Entity to Identify UE-A

Depending of the coverage state and the cast type different entities may determine UE-A according to different embodiments.

For example: In coverage, the gNB could determine UE-A.

Above, a plurality of principles have been discussed for how one UE out of multiple UEs may be determined as UE-A. This determination is performed by the UE itself so as to form a self-organizing network, or alternatively, by an external entity, e.g., the gNB. In both cases, the current conditions as well as pre-configurations may be taken into account. According to embodiments, for the determination of a UE as UE-A internal or external information may be used. For example, the current position/current cell may be determined as parameter for the selection. Also, the UE may perform a measurement, e.g., so as to determine the proximity to another UE so as to determine a parameter for the determination as UE-A. Alternatively or additionally, an internal flag, e.g., indicating an in coverage state or out of coverage state may be used.

### General

Another embodiment refers to a wireless communication system comprising one or more of the above discussed user equipments 10A, 10B or 10D. According to further embodiments, the communication system may comprise one or more base stations. Here, the base station comprises one or more of a macro cell base station, or a small cell base station, or a central unit of a base station, or a distributed unit of a base station, or a road side unit (RSU), or a UE, or a group leader (GL), or a relay or a remote radio head, or an AMF, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Examples for such a communication system are sidelink communication systems, e.g., V2x, as in the context of cellular (e.g., 3G, 4G, 5G or future), public safety communication systems, compost networks or ad hoc communication networks.

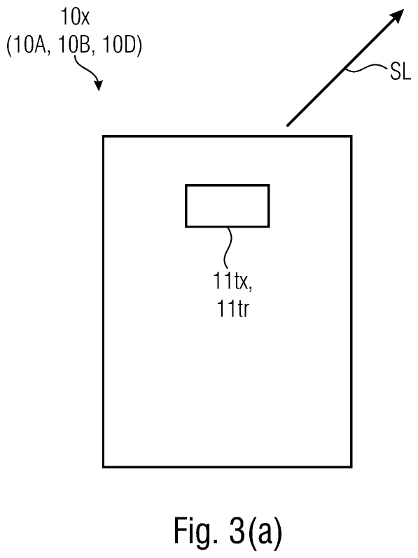

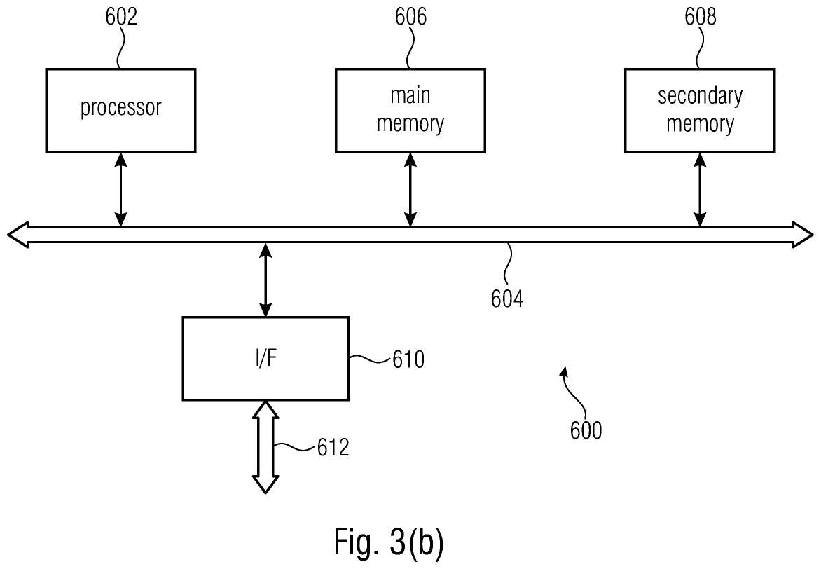

As discussed above, all aspects can be implemented by use equipment or a transmitter/transceiver of the UE. There are different types of use equipment 10A belonging to type A, 10B belong to Type B and 10D belonging to type D. FIG. 3a show an exemplary user equipment 10x, usable as a type A, type B and/or type D, comprising a transceiver 11tr or transmitter 11 tx for sidelink communications SL.

This means that an embodiment provides a first user equipment 10 selected out of one or more first and second user equipment(s); wherein one or multiple user equipment(s) out of the one or more first and second user equipment(s) are determined to be the one or more first user equipment(s) at least based on (pre-) configured conditions or criteria or measurements or explicit requests, which are defined as follows:
wherein a geographical area and/or position and/or proximity of the one or more first user equipment(s) are considered/used as a parameter to determine the one or more first one or more user equipment(s); and/or
wherein a type of first or second user equipment(s) are considered/used as a parameter to determine the one or more first user equipment(s); and/or
wherein a measured parameter is considered/used to determine the one or more first user equipment(s); and/or
wherein another parameter, e.g., an entity of first or second user equipment, is considered/used to determine the one or more first user equipment.

Regarding user equipment, it should be noted that according to embodiments, same may be out of the group of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and needing input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a base station e.g. gNB, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a transceiver, or any sidelink capable network entity.

Note all above discussed use equipment may be configured to exchange data with a base station (transmission and/or reception), e.g. using the UU interface.

As already discussed above, a user equipment can also be interpreted as base station, e.g. gNB. In such a case, the base station/gNB may determine itself as UE-A. Alternatively, the base station/gNB may determine another user equipment, e.g. a mobile device as UE-A.

This is, for example, the case when the UE determined as UE-A is in coverage of the base station. According to further embodiments, each user equipment may determine another use equipment as UE-A or may determine itself not as UE-A, so that another UE can determine itself as UE-A.

Above, it has been discussed that the aspects may be implemented by a method. Of course, the method may be computer implemented as will be discussed below.

Although the respective aspects and embodiments of the inventive approach have been described separately, it is noted that each of the aspects/embodiments may be implemented independent from the other, or some or all of the aspects/embodiments may be combined. Moreover, the subsequently described embodiments may be used for each of the aspects/embodiments described so far.

Although some of the embodiments above are described with reference to a Mode 2 UE, it is noted that the present invention is not limited to such embodiments. The teachings of the present invention as described herein are equally applicable to Mode 1 UEs carrying out sensing to obtain, e.g., a sensing report for providing an occupancy status of one or more resources or resource sets and transmitting AIMs. For example, Mode 1 UEs may aid in performing sensing for Mode 2 UEs, e.g. if operating in the same frequency band. A mode 1 UE may also be a fixed RSU which has a wired power supply, and which may, if idling in mode 1, perform services for mode 2 UEs.

Although some of the embodiments above are described with reference to a sidelink pool, it is noted that the present invention is not limited to such embodiments. Rather, the inventive approach may be implemented in a system or network providing a set or resources to be used for a certain communication between entities in the network, and the set of resources may be preconfigured so that the entities of the network are aware of the set of resources provided by the network, or the entities may be configured by the network with the set of resources. The set of resources provided by the network may be defined as one or more of the following:
a sidelink resource pool, to be used by the UE for sidelink communications, e.g. direct UE-to-UE communication via PC5,
a configured grant including or consisting of resources to be used by the UE for NR-U communications,
a configured grant including or consisting of resources to be used a reduced capability UE.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments of the present invention, the UE and/or the further UE comprise one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and needing input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a base station e.g. gNB, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a transceiver, or any sidelink capable network entity.

In accordance with embodiments of the present invention, a network entity comprises one or more of the following: a macro cell base station, or a small cell base station, or a central unit of a base station, or a distributed unit of a base station, or a road side unit (RSU), or a UE, or a group leader (GL), or a relay or a remote radio head, or an AMF, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

If the invention would be included in a Rel-17 TS, it is part of the 5G NR V2X standard and cannot be circumvented.

If specified in a TS, all UE vendors offering V2X need to apply this invention.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 3b illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

| Reference | |
|---|---|
| Label | |
| (use Word | |
| bookmarks) | Details |
| [1] | RP-202846, “WID revision: NR sidelink enhancement”, |
| | LG Electronics, RAN#90e, Dec. 7-11, 2020 |
| [2] | R1-2104103, ”FL Summary: Inter-UE coordination for |
| | Mode 2 enhancements,” LG Electronics, RAN 104e-b, |
| | April, 2021 |

### ABBREVIATIONS

| Abbreviation | Meaning |
|---|---|
| AIM | Assisted Information Message |

1. A communication system comprising one or more first user equipment(s) and one or more second user equipment(s),
wherein one or multiple user equipment(s) out of the one or more first and second user equipment(s) are selected to be the one or more first user equipment(s) at least based on explicit request which is defined as follows:
wherein another parameter from an entity of first or second user equipment is considered/used to determine the one or more first user equipment(s); and/or
wherein a second user equipment is considered to determine the one or more first user equipment; and/or
wherein the one or more first user equipment(s) is determined to be the one or more first user equipment(s) sending an assisted information message when it is triggered based on an explicit request from the one or more second user equipment(s) or (pre-)configured conditions;
wherein the assisted information message or coordination information is limited to be sent by the one or more first user equipment(s).

2. The communication system according to claim 1, wherein the one or more first user equipment(s) are configured to be determined as the one or more first user equipment(s) and/or one or more second user equipment(s) to transmit the assisted information message or coordination information; and/or
wherein the one or more first user equipment(s) and/or a further first user equipment(s) are configured to transmit inter-user equipment(s) coordination.

3. The communication system according to claim 1, wherein the one or more first user equipment(s) are determined based on a certain position of the one or more first user equipment(s) and/or second user equipment(s) and/or a geographical area of the one or more first user equipment(s) and/or second user equipment(s) and/or proximity of the one or more first user equipment(s) to the second or another user equipment(s) and/or distance between the of the one or more first user equipment(s) and the second or another user equipment(s); and/or
wherein the one or more first user equipment(s) are determined based on fulfillment of at least one of the conditions below:
zone or zone length where the one or more first user equipment(s) are; and/or wherein the zone is indicated in control information;
a threshold is provided to determine the maximum allowed distance between the one or more first user equipment(s) and the one or more second user equipment(s);
a distance or a proximity derived from an absolute position of first and second user equipment(s) or a relative distance of first and second user equipment(s);
a distance or a proximity derived from geographical information of the one or more first and second user equipment(s) (e.g. from the GNSS or from measurements (e.g. relative distance), from the received signal strength (e.g. RSSI, RSRP), or from a signal runtime or from a SL positioning reference signal.

4. The communication system according to claim 1, wherein the one or more first user equipment(s) are determined based on a type parameter; wherein the type parameter is determined based on fulfillment of at least one of the conditions below:
the one or more first user equipment(s) are a relay UE;
the one or more first user equipment(s) are configured with a certain capability (e.g. at least sensing capability or feedback transmission);
the one or more first user equipment(s) are a non-power-saving user equipment(s) (e.g. no battery-based UE, but vehicular UE);
first user equipment(s) users a defined or predefined DRX configuration (e.g. same or similar UEs, UEs comprising the same on-duration).

5. The communication system according to claim 1, wherein the type parameter is configured or (pre-)configured through the higher layer signaling.

6. The communication system according to claim 1, wherein the one or more first user equipment(s) are determined based on measurement or parameters; wherein the measurement or parameter is determined based on at least one of the conditions below:
other nearby first user equipment(s) transmitting the same AIMs;
number of first user equipment(s) transmitting the AIMs are beyond a pre-configured threshold;
load of the network (based on e.g. CBR measurement);
available/free resource of a user equipment(s) (e.g. may depend on how much resources are needed by the user equipment(s) itself);
relative velocity of the one or more first and second user equipment
received signal level;
QoS of itself towards intended second user equipment.

7. The communication system according to claim 1, wherein the measurement or parameter that is used to determine the one or more first user equipment(s) is (pre-) configured by the higher signaling and transmitted on the (pre-)configured radio resources for the AIM or other resources identified through its sensing.

8. The communication system according to claim 1, wherein the other parameter is depending on the coverage state of the one or more first user equipment(s) and the cast type of different entities; and/or
wherein the other parameter indicates an in-coverage-scenario, or wherein the other parameter indicates an in-coverage-scenario of the one or more first user equipment(s), wherein the gNB determines the one or more first user equipment(s); and/or
wherein the other parameter indicates an out-of-coverage-scenario; and/or

9. The communication system according to claim 1, wherein the other parameter indicates different cast types out of a group comprising:
Groupcast (e.g. the group head may determine UE-A);
Unicast (any of the following solution may apply, UE-A can be intended receiver of UE-B or Non-intended receiver of UE-B, which meets conditions to be determined as UE-A, the transmitting user equipment(s) could be UE-A to the receiving user equipment(s) and vice versa);
Broadcast (any of the following solution may apply: Any user equipment(s) could propose UE-A resources to be shared and UE-B decides which ones to use).

10. The communication system according to claim 1, wherein a request is sent from the one or more second user equipment(s); and/or
wherein a request is sent from the one or more second user equipment(s) requesting an information about the resources available to the one or more second user equipment(s).

11. A user equipment(s) configured to communicate within the communication system of claim 1 and forming the one or more first or second user equipment.

12. The user equipment(s) according to claim 11, wherein the user equipment(s) comprise one or more of the following: a power-limited UE, or a hand-held UE, like a user equipment(s) used by a pedestrian, and referred to as a Vulnerable Road User, VRU, or a Pedestrian UE, P-UE, or an on-body or hand-held user equipment(s) used by public safety personnel and first responders, and referred to as Public safety UE, PS-UE, or an IoT UE, e.g, a sensor, an actuator or a user equipment(s) provided in a campus network to carry out repetitive tasks and needing input from a gateway node at periodic intervals, a mobile terminal, or a stationary terminal, or a cellular IoT-UE, or a vehicular UE, or a vehicular group leader UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a base station e.g. gNB, or a moving base station, or road side unit, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g. a sensor or actuator, or a transceiver, or any sidelink capable network entity.

13. A first user equipment of a communication system comprising one or more first user equipment(s) and one or more second user equipment(s),
wherein one or multiple user equipment(s) out of the one or more first and second user equipment(s) are selected to be the one or more first user equipment(s) based on explicit request which is defined as follows:
wherein another parameter, e.g. from an entity of first or second user equipment is considered/used to determine the one or more first user equipment(s); and/or
wherein a second user equipment is considered to determine the one or more first user equipment; and/or
wherein the one or more first user equipment(s) is determined to be the one or more first user equipment(s) sending an assisted information message when it is triggered based on an explicit request from the one or more second user equipment(s) or (pre-)configured conditions;
wherein the assisted information message or coordination information is limited to be sent by the one or more first user equipment(s).

14. A second user equipment of a communication system comprising one or more first user equipment(s) and one or more second user equipment(s),
wherein one or multiple user equipment(s) out of the one or more first and second user equipment(s) are selected to be the one or more first user equipment(s)
based on explicit request which is defined as follows:
wherein another parameter, e.g. from an entity of first or second user equipment is considered/used to determine the one or more first user equipment(s); and/or
wherein the one or more first user equipment(s) is determined to be the one or more first user equipment(s) sending an assisted information message when it is triggered based on an explicit request from the one or more second user equipment(s) or (pre-)configured conditions;
wherein the explicit request is sent by the one or more second user equipment(s);
wherein the request is sent from the one or more second user equipment(s) requesting an information about the resources available to the one or more second user equipment(s).

15. A method for performing communication within a communication system comprising one or more first user equipment(s) and one or more second user equipment(s), the method comprising the step of determining,
wherein one or multiple user equipment(s) out of the one or more first and second user equipment(s) are selected to be the one or more first user equipment(s) based on explicit request which is defined as follows:
wherein another parameter, e.g. from an entity of first or second user equipment is considered/used to determine the one or more first user equipment(s); and/or
wherein a second user equipment is considered to determine the one or more first user equipment; and/or
wherein the one or more first user equipment(s) is determined to be the one or more first user equipment(s) sending an assisted information message when it is triggered based on an explicit request from the one or more second user equipment(s) or (pre-)configured conditions;
wherein the assisted information message or coordination information is limited to be sent by the one or more first user equipment(s).

16. A non-transitory digital storage medium having a computer program stored thereon to perform the method for performing communication within a communication system comprising one or more first user equipment(s) and one or more second user equipment(s), the method comprising the step of determining,
wherein one or multiple user equipment(s) out of the one or more first and second user equipment(s) are selected to be the one or more first user equipment(s) based on explicit request which is defined as follows:
wherein another parameter, e.g. from an entity of first or second user equipment is considered/used to determine the one or more first user equipment(s); and/or
wherein a second user equipment is considered to determine the one or more first user equipment; and/or
wherein the one or more first user equipment(s) is determined to be the one or more first user equipment(s) sending an assisted information message when it is triggered based on an explicit request from the one or more second user equipment(s) or (pre-)configured conditions;
wherein the assisted information message or coordination information is limited to be sent by the one or more first user equipment(s),
when said computer program is run by a computer.
